(19) United States
(12) Patent Application Publication
(10) Pub. No.: US 2001/0010785 A1
(43) Pub. Date: Aug. 2, 2001

(54) Tool interconnect structure

(75) Inventor: John M. Cirino, Kirtland, OH (US)

Correspondence Address: PEARNE & GORDON LLP, 526 SUPERIOR AVENUE EAST, SUITE 1200, CLEVELAND, OH, 44114-1484, US

(73) Assignee: Master Tool Corporation

(21) Appl. No.: 09/761,393

(22) Filed: Jan. 16, 2001

Related U.S. Application Data
(63) Continuation-in-part of application No. 09/390,909, filed on Sep. 7, 1999.
(60) Provisional application No. 60/099,967, filed on Sep. 11, 1998.

(51) Int. Cl. B23B 31/10

(52) U.S. Cl. 409/234; 408/239 R; 279/67

(57) ABSTRACT

A tool interconnect structure includes a spindle adapter, a rotary cutting tool, and a lock mechanism securing the rotary cutting tool to the spindle adapter. The spindle adapter has a face with a short hollow tapered shank at the face. The rotary cutting tool has a face for engaging the spindle adapter face and a tapered recess at the face for cooperating with the tapered shank. The lock mechanism includes a pair of blocks having shoulders at their ends adapted to engage annular grooves within the hollow tapered shank and within the rotary cutting tool. The blocks have threaded apertures therethrough and a screw having oppositely threaded end portions extends through the apertures. Rotation of the screw causes the shoulders to engage with and disengage from the grooves.

This application is a continuation-in-part of copending application Ser. No. 09/390,909 filed Sep. 7, 1999, which claims the benefit of provisional application Serial No. 60/099,967 filed Sep. 11, 1998.

### BACKGROUND OF THE INVENTION

The present invention generally relates to cutting tools and, more particularly, to the connection of rotary cutting tools to spindles.

Recently, a new interface between a rotary cutting tool and a spindle adapter was developed seeking solutions to various problems relating to interfaces using a steep angle taper and/or long taper. Particularly improvement was desired with regard to static and dynamic elasticity, tool change precision, and deformation at high speeds. As a result of this development, DIN standard 69893 issued which is directed to the dimensional relationships of a hollow short taper shank of a cutting tool and an associated recess in a spindle adapter. The DIN standard, however, does not address the structure or operation in which the tool shank can be gripped or expanded from its interior to press the shank against the mating recess of the adapter.

A number of cutting tool manufacturers have developed different clamping or locking mechanisms for this interface between the cutting tool and the spindle adapter. Each manufacturer secures the lock mechanism to the spindle adapter within the tapered recess. Typically, the clamping mechanism includes a series of projections or fingers which can be selectively moved radially inward and outward. Once the tapered shank of the cutting tool is properly positioned within the tapered recess of the spindle adapter, an actuating screw of the clamping assembly provides radial movement of the fingers. Rotation of the screw in one direction moves the fingers radially outward into engagement with the internal surface of the shank hollow interior within an internal groove to form an interference in the longitudinal direction.

When tool changeover is required, rotation of the actuator screw in the other direction retracts the fingers radially inward to remove the interference so that the cutting tool shank can be removed. The lock mechanism remains in place in the tapered recess of the spindle adapter, making the tapered recess into a narrow annular recess. A new cutting tool shank is then inserted into the tapered recess of the spindle adapter over the lock mechanism and the same process is followed to secure the cutting tool to the spindle adapter.

While this interface may be an adequate solution for some cutting tool applications, particularly CNC machining centers, the interface may pose additional problems for other cutting tool applications, particularly dedicated spindles. One problem relates to the internal groove which has tolerances which are very difficult to maintain. As a result, the tool is very difficult and expensive to produce. Unfortunately, this internal groove tolerancing is only for the purpose of clamping the cutting tool. There is also some question as to the strength of the narrow wall thickness at the location of the internal groove.

Another problem relates to cleaning. It is of primary importance that the mating, tapered surfaces of the spindle adapter recess and the cutting tool shank be kept clean. Any chips from the cutting operation that become lodged in the recess must be removed. The known lock mechanisms limit accessibility to the tapered recess in the spindle adapter as described above since the lock mechanism is mounted and retained therein. This is particularly a problem in dedicated spindle applications such as transfer line, dial, and trunion line machines which generally require manual tool changing and frequently have limited visual and physical access thereto. With the clamping mechanism located in the female end, it is virtually impossible to clean the spindle adapter recess. Operators cannot get their fingers inside to wipe the female socket. Chips, dirt, and coolant with small metal filings will most certainly freeze the clamping mechanism, making it impossible to remove the cutting tool. It is not practical to develop inside air blast cleaning for manual installations and external air blasts throw the chips back into the mechanism. Accordingly, there is a need in the art for an improved cutting tool interface.

The invention set forth in copending application Ser. No. 09/390,909 filed Sep. 7, 1999 provides a cutting tool interface which solves at least some of the above-noted problems. The tool interconnect structure according to that invention includes a spindle adapter having a tapered shank, a rotary cutting tool having a tapered recess sized and shaped for cooperating with the tapered shank, and a lock mechanism securing the tapered shank within the tapered recess. By putting the tapered recess, the female portion, on the cutting tool it can be more easily cleaned because it is free of the machine.

According to another aspect of that invention, a tool interconnect structure includes a spindle adapter and a rotary cutting tool. One of the adapter and the rotary cutting tool has a tapered shank and the other has a tapered recess cooperating with the tapered shank. A lock mechanism secures the tapered shank in the tapered recess. The lock mechanism includes a first retention stud secured within the tapered recess and at least one lock element within the tapered shank for selectively interconnecting with retention stud. By putting only a retention stud in the tapered recess, the female portion, the recess can be more easily cleaned because it no longer is just a thin annular groove. Additionally, the tapered shank no longer requires an internal groove so that it is easier to produce and has a greater wall thickness.

### BRIEF SUMMARY OF THE INVENTION

The present invention provides a cutting tool interface which has all of the invention described in the copending application and provides further advantages. The tool interconnect structure according to the present invention includes a spindle adapter and a rotary cutting tool. One of the adapter and the rotary cutting tool has a tapered shank and the other has a tapered recess cooperating with the tapered shank. A lock mechanism secures the tapered shank in the tapered recess. The lock mechanism secures the tapered shank in the tapered recess. The lock mechanism comprises at least one block element having first and second shoulders or wedges which are adapted to respectively engage complementary wedge faces on first and second abatements within annular grooves on the spindle adapter and the cutting tool. The locking mechanism is provided in a central recess defined by the spindle adapter and the cutting tool and is moved radially outwardly to lock the tapered shank in the tapered recess and is moved radially inwardly to permit the cutting tool to be removed from the spindle adapter. Radial movement is provided by a screw mechanism. Desirably, a pair of oppositely facing locking mechanisms are provided on a universal screw which advances the mechanisms radially outwardly when turned in one direction and retracts the mechanisms radially inwardly when turned in an opposite direction. The entire locking mechanism may be removed for cleaning.

### BRIEF DESCRIPTION OF THE DRAWINGS

FIG. 1 is an elevational view of a rotational cutting tool connected to a spindle adapter according to the present invention;

FIG. 2 is an enlarged fragmented view, in cross-section, showing the interconnection of FIG. 1 in a locked condition;

FIG. 3 is an enlarged fragmented view, in cross-section, similar to FIG. 2 but showing the interconnection of FIG. 1 in an unlocked condition;

FIG. 4 is a perspective view of a locking element; and

FIG. 5 is a cross-sectional view, the plane of the section being indicated by the line 5-5 in FIG. 4.

### DETAILED DESCRIPTION OF THE INVENTION

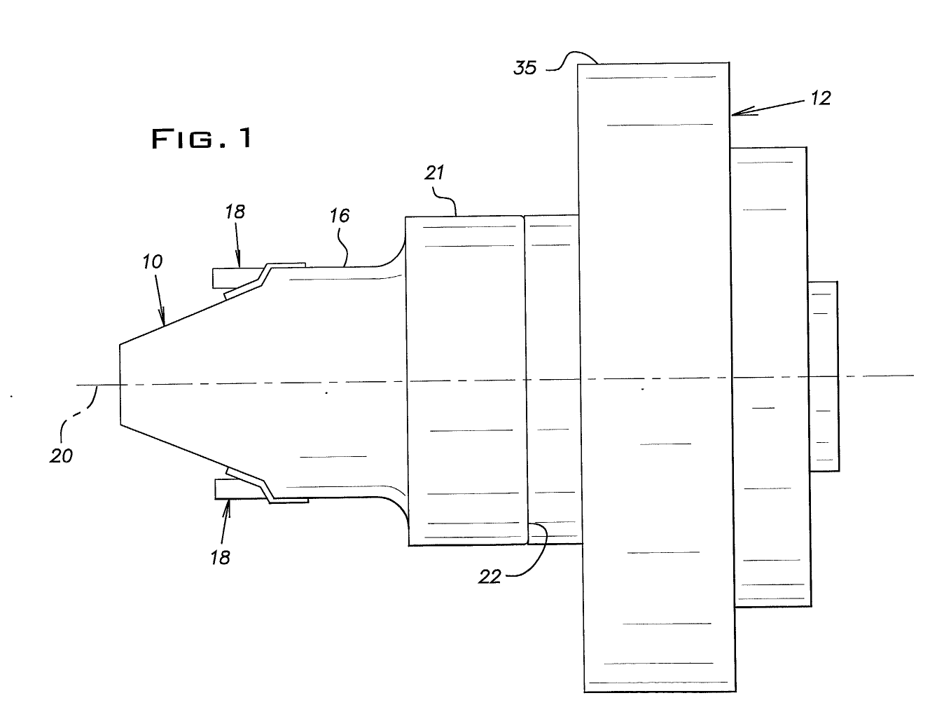

FIGS. 1-3 illustrate a rotary cutting tool interconnect structure according to the present invention. The interconnect structure includes a rotary cutting tool 10, a spindle adapter 12 to which the rotary cutting tool 10 is secured, and a clamp or lock mechanism 14 releasably securing the rotary cutting tool 10 to the spindle adapter 12.

The rotary cutting tool 10 of the illustrated embodiment is a valve seat assembly tool but it is noted that other types of rotary cutting tools can be utilized within the scope of the present invention. The rotary cutting tool 10 includes a main body 16 and one or more cartridges or inserts 18 secured to the body to provide precision cutting surfaces mounted at predetermined positions for particular cutting operations. The illustrated cutting surfaces are for forming valve seats in an engine. Preferably, the inserts 18 are removable so that once the cutting surfaces become worn, the inserts 18 can be easily replaced and the new cutting surfaces are disposed at the proper angle and orientation.

The main body 16 is adapted to be longitudinally located on a rotational axis 20 of a spindle for rotation with the spindle as described in more detail hereinafter. The main body is sized and shaped to provide the desired mass and strength for performing a particular cutting operation. A first or rear end of the rotary cutting tool 10 has a shoulder portion 21 which forms a rear face 22 substantially perpendicular to the rotational axis 20. The rear face 22 limits insertion of the spindle adapter 12 into the rotary cutting tool 10 as described in more detail hereinafter. The shoulder portion 21 also forms a front face 23. A land portion 23a is disposed on the forward side of the shoulder and has a diameter smaller than the shoulder portion. Recesses are provided in the land portion which are adapted to receive the removable inserts 18. A nose portion 23b is disposed on the forward side of the land portion 23a to form a second or forward end which tapers to a minimum diameter. The second end is dimensioned for receipt in an opening of an engine head in which valve seats are to be formed or cut by the rotary cutting tool 10.

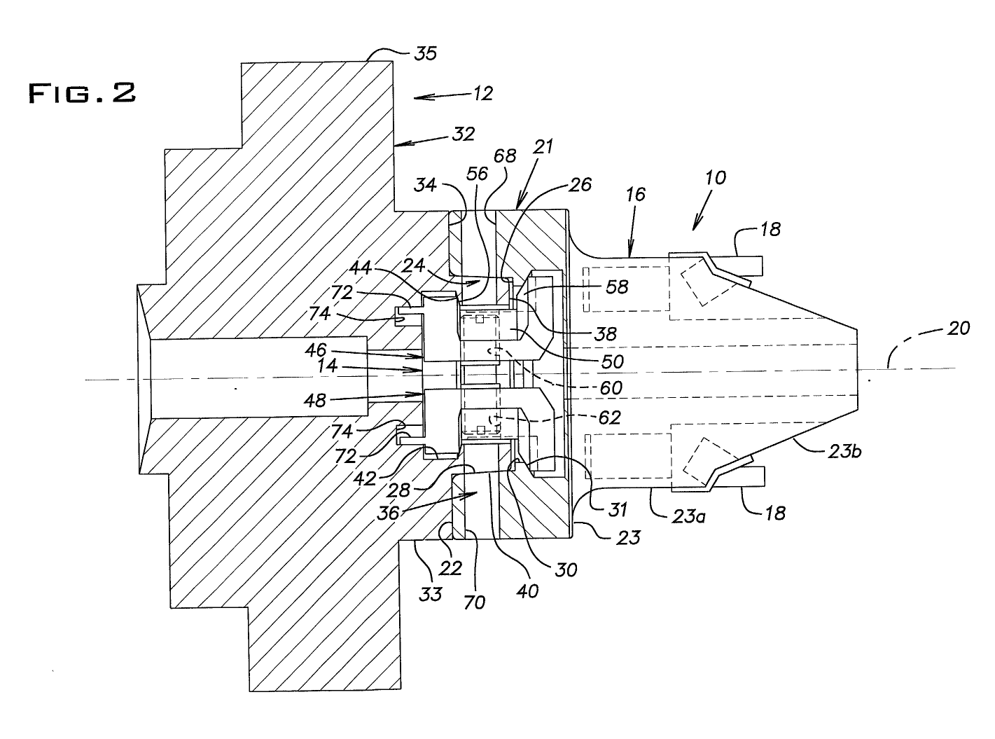

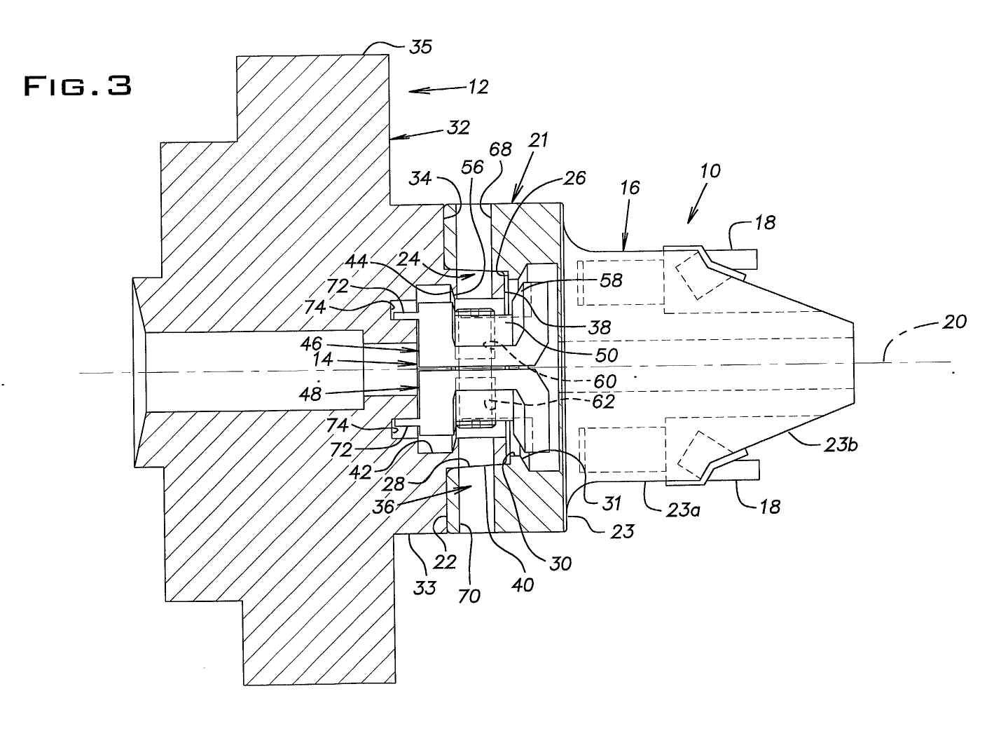

As best shown in FIGS. 2 and 3, a tapered recess 24 is formed in the rear face 22 at the first end of the cutting tool main body 16 and centered on the rotational axis 20. The tapered recess 24 has a planar bottom wall 26 substantially perpendicular to the rotational axis 20 and a tapered side wall 28 which decreases in diameter from a maximum diameter near the rear face 22 to a minimum diameter near the bottom wall 26. The tapered recess 24 is sized and shaped to provide a mating fit with the spindle adapter 12 as described in more detail hereinbelow. A longitudinally extending bore or opening 30 is centered on the rotational axis 20 and opens into the tapered recess 24 through the bottom wall 26. The wall 26, the bore 30, and a sloping face 31 of an annular groove 31a form a locking surface for the locking mechanism 14 as will be explained in greater detail.

As shown in FIG. 1, the spindle adapter 12 has a body 32 adapted to be longitudinally located on the rotational axis 20 for rotation with the spindle as described in more detail hereinafter. The spindle adapter 12 can be an integral portion of the spindle or a separate component secured thereto. The body 32 is sized and shaped to provide the desired mass and strength for cooperating with the rotary cutting tool to perform the particular cutting operation. A nose portion 33 of the adapter 18 has a diameter smaller than a first shoulder portion 35. The nose portion 33 forms a forward face 34 substantially perpendicular to the rotational axis 20. The forward face 34 cooperates with the rear face 22 of the rotary cutting tool 10 to limit insertion of the spindle adapter 12 into the rotary cutting tool 10 as described in more detail hereinafter.

As best shown in FIGS. 2 and 3, a tapered shank 36 is formed at the forward face 34 of the spindle adapter body 32 and centered on the rotational axis 20. The tapered shank 36 has a planar front edge substantially perpendicular to the rotational axis 20 and a tapered side wall 40 which increases in diameter from a maximum diameter near a front edge 38 to a maximum diameter near the forward face 34. The tapered shank 36 is sized and shaped to provide a mating fit with the cutting tool tapered recess 24 as described in more detail hereinbelow.

The tapered shank 36 is hollow and has an annular groove 42 which forms a sloping face 44. The face 44 forms a locking surface for the locking mechanism 14 as will be explained in greater detail.

The tapered shank 36 is sized to have a shallow angle similar to those required by DIN 69893 (for short tapered, face contact, hollow shank connection). The taper of the shank 36 is preferably about 10/1 and is preferably in the range of about 1½ degrees to about 3 degrees. The tapered shank 36, however, has a length which is shorter than those required by DIN 69893. For typical cutting tools, the length of the tapered shank 36 is preferably less than 7/16 inch and is preferably greater than ¼ inch.

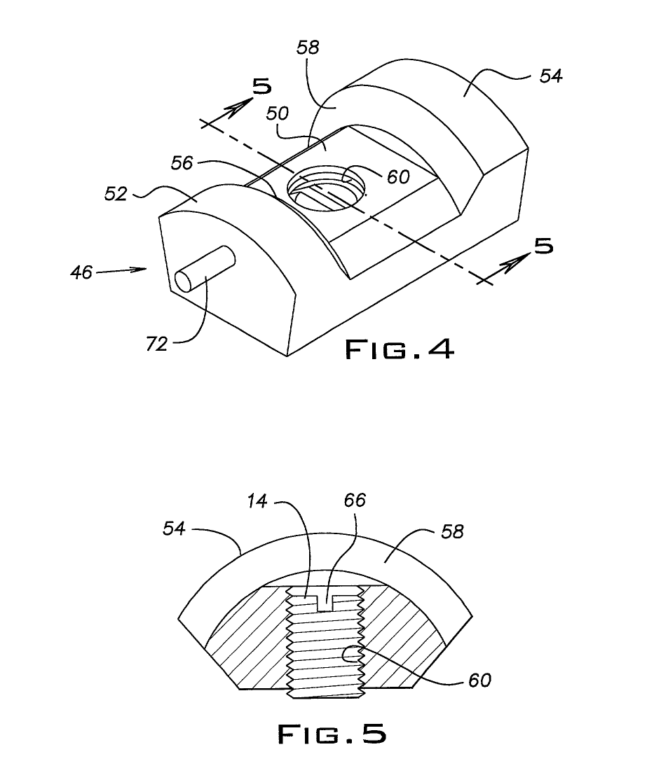

The lock mechanism 14 includes a pair of wedge blocks 46 and 48. The blocks 46 and 48 are substantially identical and, with particular reference to FIGS. 4 and 5, only the block 46 will be described in detail. The block 46 includes a body portion 50 having first and second shoulder portions 52 and 54. The shoulder portions 52 and 54 respectively define wedge faces 56 and 58 which are adapted to cooperate with the sloping faces 44 and 31, respectively, to lock the cutting tool 10 to the spindle adapter 12, as will become apparent.

The blocks 46 and 48 are provided with oppositely threaded bores 60 and 62 which are oppositely threaded. A universal screw 64 ties the blocks 46 and 48 together and has oppositely threaded end portions which, upon rotation in a first direction, will draw the blocks 46 and 48 toward each other and which, upon rotation in an opposite direction, will move the blocks 46 and 48 apart. Each end of the screw 64 is provided with a slot 66 so that turning access may had to either end of the screw 64 through radial bores 68 and 70 which extend through the tapered connection between the tool 10 and the adapter 12. Other mechanisms such as cams may be employed to move the blocks into and out of contact with the sloping faces 44 and 31. Each block 46 and 48 is provided with a locating pin 72 and each pin 72 is received in radially extending locating slots 74 in the spindle adapter 12. This arrangement ensures that the axis of the screw 64 is aligned with the bores 68 and 70 upon installation of the blocks 46 and 48 and during operation.

FIG. 2 illustrates the lock mechanism 14 in its locking condition with the blocks 46 and 48 in a separated position and with the wedge faces 56 and 58 in locking contact with the sloping faces 44 and 31, respectively. In order to move the lock mechanism 14 to the unlocked position illustrated in FIG. 3, a screwdriver is inserted in either of the bores 68 and 70 and the screw 64 is rotated to draw the blocks 46 and 48 together and to a position providing axial clearance between the wedge faces 56 and 58 and the sloping faces 43 and 31.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. A tool interconnect structure comprising a spindle adapter having a hollow tapered shank, a rotary cutting tool having a tapered recess sized and shaped for cooperating with said tapered shank, a lock mechanism securing said tapered shank within said tapered recess, said lock mechanism comprising at least one block within said hollow tapered shank, said at least one block having shoulder portions adapted to engage annular grooves within the hollow tapered shank and within the rotary cutting tool, and means to move said at least one block into and out of engagement with said grooves.

2. A tool interconnect structure according to claim 1 wherein said means to move said at least one block is a screw.

3. A tool interconnect structure according to claim 1 wherein said at least one block comprises a pair of blocks.

4. The tool interconnect structure according to claim 1, wherein said tapered shank has a taper of about 10/1.

5. The tool interconnect structure according to claim 1, wherein said tapered shank has a taper of about 1½ to about 3 degrees.

6. The tool interconnect structure according to claim 1, wherein said tapered shank has a length of less than 7/16 inch.

7. The tool interconnect structure according to claim 6, wherein said tapered shank has a length of greater than ¼ inch.

8. The tool interconnect structure according to claim 1, wherein said spindle adapter has a longitudinal axis and a face substantially perpendicular to said longitudinal axis.

9. The tool interconnect structure according to claim 8, wherein said cutting tool has a longitudinal axis and a face perpendicular to said longitudinal axis, and said face of said cutting tool is adapted to engage said face of said spindle adapter when said lock mechanism secures said tapered shank within said tapered recess.

10. A tool interconnect structure comprising a spindle adapter having a hollow tapered shank, a rotary cutting tool having a tapered recess sized and shaped for cooperating with said tapered shank, a lock mechanism securing said tapered shank within said tapered recess, said lock mechanism comprising a pair of blocks each having shoulder portions adapted to engage annular grooves within the hollow tapered shank and within the rotary cutting tool, each of said pair of blocks having a threaded aperture therethrough, a universal screw having oppositely threaded end portions threadedly received in each aperture, whereby rotation of said screw in one direction moves said shoulder portions into engagement with said grooves and movement of said screw in an opposite direction moves said shoulder portions out of engagement with said grooves, and radially aligned access openings through said tapered recess and said tapered shank to the end portions of said screw.

11. A tool interconnect structure according to claim 10 wherein said shoulders and said grooves have mating faces which are sloped relative to a longitudinal axis of said adapter and said shank.

12. The tool interconnect structure according to claim 10, wherein said tapered shank has a taper of about 10/1.

13. The tool interconnect structure according to claim 10, wherein said tapered shank has a taper of about 1½ to about 3 degrees.

14. The tool interconnect structure according to claim 10, wherein said tapered shank has a length of less than 7/16 inch.

15. The tool interconnect structure according to claim 14, wherein said tapered shank has a length of greater than ¼ inch.

16. The tool interconnect structure according to claim 10, wherein said spindle adapter has a longitudinal axis and a face substantially perpendicular to said longitudinal axis.

17. The tool interconnect structure according to claim 16, wherein said cutting tool has a longitudinal axis and a face perpendicular to said longitudinal axis, and said face of said cutting tool is adapted to engage said face of said spindle adapter when said lock mechanism secures said tapered shank within said tapered recess.
